(19) United States
(12) Patent Application Publication
(10) Pub. No.: US 2024/0375006 A1
(43) Pub. Date: Nov. 14, 2024

(54) SYSTEMS, METHOD, AND NON-TRANSITORY COMPUTER-READABLE STORAGE MEDIA FOR RENDERING A TRADING CARD GAME ON A DISPLAY DEVICE

(71) Applicant: ACQS LLC, Las Vegas, NV (US)

(72) Inventor: Daxton Lyon, Las Vegas, NV (US)

(21) Appl. No.: 18/662,890

(22) Filed: May 13, 2024

Related U.S. Application Data
(60) Provisional application No. 63/466,168, filed on May 12, 2023.

(51) Int. Cl. A63F 13/58; A63F 13/30; A63F 13/73

(52) U.S. Cl. CPC A63F 13/58; A63F 13/30; A63F 13/73

(57) ABSTRACT

A networked computer system is described herein. The networked computer system includes a plurality of user computing devices, a non-fungible token (NFT) blockchain system storing ownership data associated with virtual trading cards, and a web3.0 cloud platform including one or more processors coupled to the plurality of user computing devices and to the NFT blockchain system. The one or more processors are programmed to execute an algorithm to render animated sequences of computer-generated images of a trading card game on the user computing devices including the steps of: receiving a request by a player to play the trading card game, querying a trading card NFT wallet software module to access data stored on the NFT blockchain system to determine NFT hero trading cards currently owned by the player, populating a hero trading card deck associated with the player including the NFT hero trading cards currently owned by the player.

### CROSS-REFERENCE TO RELATED APPLICATION

This application claims the benefit of U.S. Provisional Patent Application Ser. No. 63/466,168, filed May 12, 2023, the disclosures of which are hereby incorporated by reference in their entirety.

### TECHNICAL FIELD

The present invention relates to a networked computer system including one or more processors programmed to execute an algorithm to render animated sequences of computer-generated images of an NFT trading card game on the user computing devices.

### BACKGROUND

Cryptocurrency is a free-market innovation with the goal of liberating consumers from a centrally controlled economy. Compared to fiat money/currency, which is legal tender whose governance and value are centrally backed by a government issuer and managed by one or more central banks, cryptocurrency is a decentralized digital asset whose governance and value are backed by a consortium of independent investors and/or miners/stakers, and managed through a blockchain. Although blockchain technology provides a new framework for information technology, the space is still lacking structure like the Internet circa 1993 or the Web circa 2000.

A blockchain is an interconnected group of distributed computers who maintain a common ledger for transaction validations. Since blockchains are typically decentralized and distributed, they offer the opportunity for better security protections and greater transparency than Web 1.0 or 2.0 offer. Therefore, the opportunity for cryptocurrency is to form a new Internet platform called Web 3.0 that leverages blockchain technology to be more transparent and secure.

Blockchains are identified as Layer 1 cryptocurrencies, which means that they function like an operating system on a computer insomuch that they provide a platform for other software to be built on to reside in the space. Layer 2 cryptocurrencies on the other hand are called decentralized applications (dApps), which are autonomous applications that typically utilize smart contracts to provide goods, functions, services, or utilities. Layer 0 cryptocurrencies connect blockchains together.

In terms of revenue, Layer 1 cryptocurrencies generate revenue by charging fees to their users on a per network/blockchain transaction called “gas.” Like governments who issue fiat currency to citizens and collect taxes; Layer 1 cryptocurrencies issue tokens to investors or miners/stakers and collect gas.

Layer 2 cryptocurrencies do not have a standard revenue model like Layer 1s because they have broad and diverse utility. For example, one kind of dApp may be a play-2-earn (P2E) video game. A P2E game rewards players with cryptocurrency tokens for their gaming participation. Another kind of dApp might be a store that sells unique, non-replicable digital media called Non-fungible tokens (NFTs). Artwork, music, motion-pictures, photograph, games etc. are forms that NFTs can take. New and dynamic forms of NFTs are being developed daily, such as Trading Card Game NFTs.

Most cryptocurrency projects are dApps. Many dApps aim to create projects that have or are expected to deliver value for long-term sustainability. However, with the explosion of cryptocurrency going mainstream, the market has created a “Cryptocurrency Unattainable Triangle,” which is to say that any given crypto project can have any two of the following qualities, but not all three: reliability, sustainability, and a high return on investment.

There is no better sector in crypto to prove the Crypto Unattainable Triangle than Decentralized Finance (DeFi). The vision of DeFi is to offer the public an alternative mechanism for finance that is decentralized and independent of intermediaries. Through blockchain technology, DeFi drastically reduces-if not eliminates—the traditional need for central authorities (e.g., banks, lending institutions, and other financial intermediaries) to mediate or foster financial transactions/services. However, many DeFi projects are dependent on market attraction, participation, and retail investments to get started.

To attract investment capital, many DeFi projects are built to offer extraordinary returns on investment that are not sustainable long-term (i.e., reliability plus high ROI less sustainability). Without reliable economic models, the future of many DeFi projects are bleak at best. Poorly constituted projects that over-promise returns on investment depend on what the market calls “Ponzinomics.”

In crypto, Ponzinomics defines an economic model that is dependent on future investments to pay for the returns of initial investors. Many cryptocurrency projects have great ideas and are backed by good teams, but their product/service offerings and economic models are often lacking in composition, structure, function, or execution. Add to the problem an inflationary token and unbridled reward liabilities and most of these projects fail.

The present invention is aimed at one or more of the problems identified above.

### SUMMARY OF INVENTION

In one aspect of the present invention, a networked computer system is provided. The networked computer system includes a plurality of user computing devices, a non-fungible token (NFT) blockchain system storing ownership data associated with virtual trading cards, and a web3.0 cloud platform including one or more processors coupled to the plurality of user computing devices and to the NFT blockchain system. The one or more processors are programmed to execute an algorithm to render animated sequences of computer-generated images of a trading card game on the user computing devices including the steps of: receiving a request by a player via a corresponding user computing device to play the trading card game, querying a trading card NFT wallet software module to access data stored on the NFT blockchain system to determine NFT hero trading cards currently owned by the player, populating a hero trading card deck associated with the player including the NFT hero trading cards currently owned by the player; conducting a squad selection sequence by rendering a hero selection board on the user computing device including a plurality of cells arranged in a grid with each cell populated with an NFT hero trading card selected from the hero trading card deck, randomly selecting a squad selection shape including a predefined arrangement of cells, and selecting a squad of NFT hero trading cards by selecting a group of NFT hero trading cards from the hero selection board based on the squad selection shape, and animating a battle board onto the user computing device including the selected squad of NFT hero trading cards.

In another aspect of the present invention, a method of operating a networked computer system including a plurality of user computing devices, a non-fungible token (NFT) blockchain system storing ownership data associated with virtual trading cards, and a web3.0 cloud platform including one or more processors coupled to the plurality of user computing devices and to the NFT blockchain system is provided. The method includes the one or more processors performing an algorithm to render animated sequences of computer-generated images of a trading card game on the user computing devices including the steps of: receiving a request by a player via a corresponding user computing device to play the trading card game, querying a trading card NFT wallet software module to access data stored on the NFT blockchain system to determine NFT hero trading cards currently owned by the player, populating a hero trading card deck associated with the player including the NFT hero trading cards currently owned by the player; conducting a squad selection sequence by rendering a hero selection board on the user computing device including a plurality of cells arranged in a grid with each cell populated with an NFT hero trading card selected from the hero trading card deck, randomly selecting a squad selection shape including a predefined arrangement of cells, and selecting a squad of NFT hero trading cards by selecting a group of NFT hero trading cards from the hero selection board based on the squad selection shape, and animating a battle board onto the user computing device including the selected squad of NFT hero trading cards.

In yet another aspect of the present invention, a non-transitory computer-readable storage media having computer-executable instructions embodied thereon to operate a networked computer system including a plurality of user computing devices, a non-fungible token (NFT) blockchain system storing ownership data associated with virtual trading cards, and a web3.0 cloud platform including one or more processors coupled to the plurality of user computing devices and to the NFT blockchain system is provided. When executed by the one or more processors, the computer-executable instructions cause the one or more processors to perform an algorithm to render animated sequences of computer-generated images of a trading card game on the user computing devices including the steps of: receiving a request by a player via a corresponding user computing device to play the trading card game, querying a trading card NFT wallet software module to access data stored on the NFT blockchain system to determine NFT hero trading cards currently owned by the player, populating a hero trading card deck associated with the player including the NFT hero trading cards currently owned by the player; conducting a squad selection sequence by rendering a hero selection board on the user computing device including a plurality of cells arranged in a grid with each cell populated with an NFT hero trading card selected from the hero trading card deck, randomly selecting a squad selection shape including a predefined arrangement of cells, and selecting a squad of NFT hero trading cards by selecting a group of NFT hero trading cards from the hero selection board based on the squad selection shape, and animating a battle board onto the user computing device including the selected squad of NFT hero trading cards.

### BRIEF DESCRIPTION OF THE FIGURES

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic illustrating various aspects of a system for use in rendering a trading card game to players using non-fungible tokens (NFT) recorded in a blockchain system, according to the present disclosure;

FIG. 2 is a flow chart illustrating an algorithm used during operation of the system to render animated sequences on computer-generated images of the trading card game on display devices, according to the present disclosure;

FIG. 3 is a schematic illustration of a Hero Selection Board used during the trading card game;

FIGS. 4-10 are schematic illustrations of Hero Trading Cards that may be used during the trading card game;

FIGS. 11-13 are schematic illustrations of Action Cards that may be used during the trading card game;

FIGS. 14-16 illustrate algorithms executed by the system to render animated sequences on computer-generated images of a squad selection sequence implemented during the trading card game;

FIG. 17 is a schematic illustration of a Battle Board used during the trading card game; and

FIGS. 18-30 illustrate algorithms executed by the system to render animated sequences on computer-generated images of a squad battle sequence implemented during the trading card game.

Corresponding reference characters indicate corresponding parts throughout the drawings.

### DETAILED DESCRIPTION

With reference to the drawings and in operation, the present invention is directed to a networked computer system configured to render animated sequences of computer-generated images of a trading card game on user computing devices using non-fungible tokens (NFT) recorded in a blockchain system.

The game is a Battle Blitz™ trading card strategy game played between two players. Each player's objective is to capture the opponent's supreme character (e.g., King piece in chess or Queen Bee in one of the Battle Blitz iterations of the game). To complete the objective, each player must fight through squads of characters (i.e., 3 squads totaling 15 characters) (e.g., swarms of bees in one Battle Blitz iteration) and survive.

Per each player, the elements of the game include one Character Board (i.e., a 5×5 trading card matrix), 25 preselected and organized character trading cards (sometimes referred to as “Hero” trading cards), one Battle Board (space areas for squads, the supreme character, remaining character deck, killed character discard pile, game deck, and game deck discard pile), and a 52-card Game deck that includes each player's supreme character. For the physical trading card game, additional game pieces will include Hit Point (HP) and Booster game pieces. Any space between each player's Battle Board is the Game Card Play Area.

To play the game, two or more players/teams play a high-card game called “War.” If the competition is between two players/teams, then the War game will play to a best of five competition. If the competition is between more than two players/teams, then every player/team representative will draw a card and the two highest cards will face-off for the best of five War competition. In the event of a three-way tie (or more), a stalemate occurs, which means that the cards for that round will be discarded and the process will repeat until only two players/teams have the highest cards to play the best of five War game. The point of the War game is to determine who will select their squads first or defer their selection for the advantage to start the game on offense. When there are more than two players/teams then the point of selection will begin with the selecting party and move clockwise.

To make squad selections, each player uses a Character Board-a 5×5 matrix of Hero cards—to fill their Battle Board with three squads and the Supreme Character. To make the Battle Board, the players will retrieve five sequential action cards (labeled 2-6) from their game deck plus the Supreme Character. Each player will take their six cards and shuffle them before laying them out in a row in front of each other for their opponent to choose from. With more than two players, the selection process will rotate clockwise. The last step is for each player to select three squads based on the numbers they draw in a 1, 2, 1, 2 . . . sequence that reverses to a 2, 1, 2, 1 . . . sequence for the second selection so that every player has selected three squads.

Once the selection process is complete, the players will each organize their three squads of five Heroes into their Battle Board formations. The formations will be formed with each player's cards face down until all boards are set at which time the players will each turnover their front-line squads and then draw five cards from their respective game decks. The heads-up War player/team who did not make the first squad selection will be on offense while every other player/team will be on defense. The players/teams will go back and forth between offense and defense attacking each other until one of the players/teams captures the Supreme Character, defeats all of the other player's/team's squads, or players/teams forfeit.

The strategy of the game is to combine the quality of the cards drawn from each deck—like in poker—with the skills and abilities of each Hero—like in Magic the Gathering—to overwhelm the opponent's squads and capture the Supreme Character—like in chess.

Before a game starts, players must have filled their Character Board with 25 strategically positioned Hero cards. To complete the task, players must acquire Heroes first. To acquire Heroes, players can buy packs of 5 cards for $1,000 USD per-pack, or the $COMB/$USDC equivalent. Players can also pay to randomly draw individual cards of a specified rarity for a fee. Alternatively, players can buy specific individual cards from one of ACQS' aftermarket stores (e.g., $COMB).

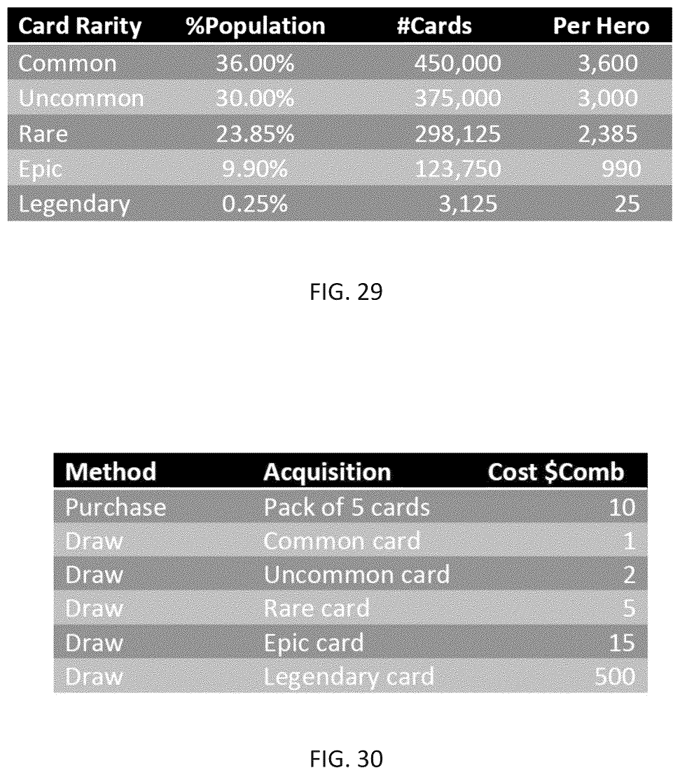

The total supply of cards is anticipated to be 10,000× the number of unique Heroes designated for production (est. 125), which is a total of 1,250,000 cards for Season 1. The distribution of cards is shown in FIG. 29.

In addition, players will be able to lease cards from other players to fill their Character Boards and compete in games. The bottom line is that there are many ways to acquire Heroes so that one can play the game. The Hero acquisition methods for the game are shown in FIG. 30. Purchased and drawn game cards will be sold online via authorized marketplaces. The cards will be purchasable via cryptocurrency tokens (e.g., $Comb or $USDC).

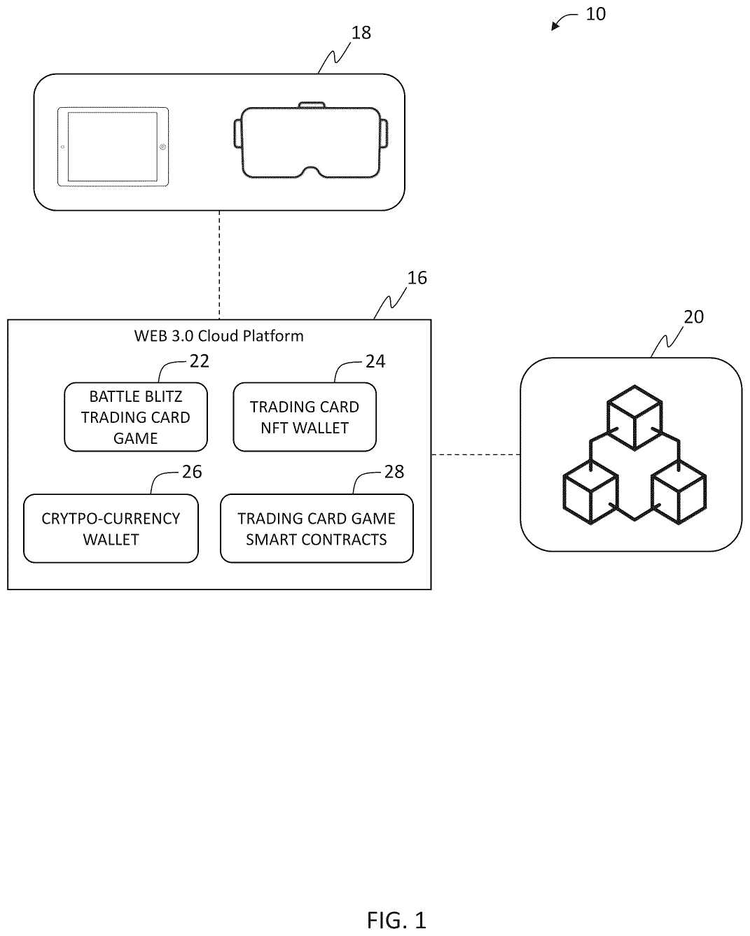

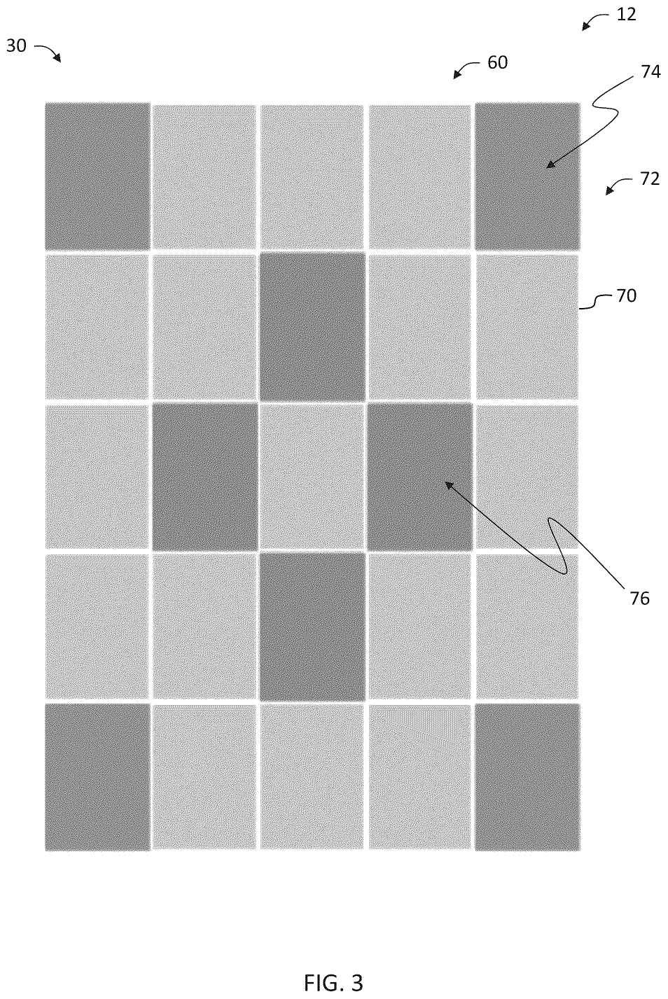

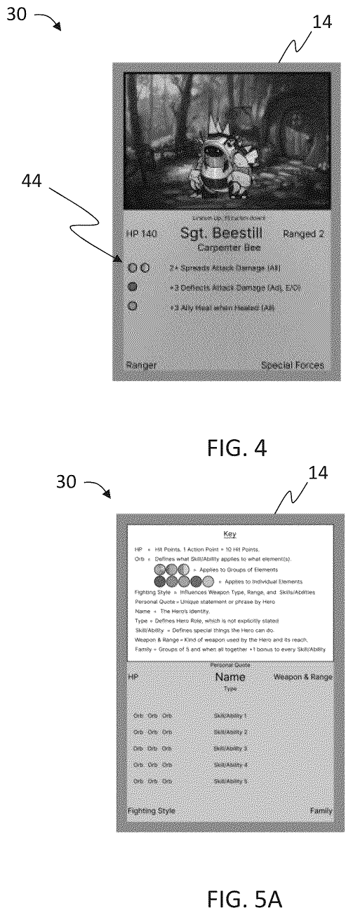

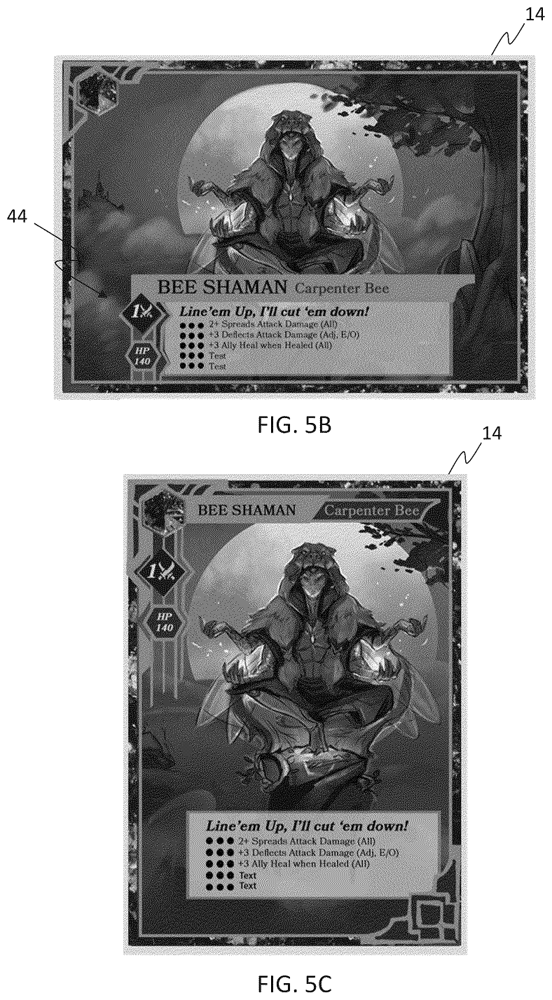

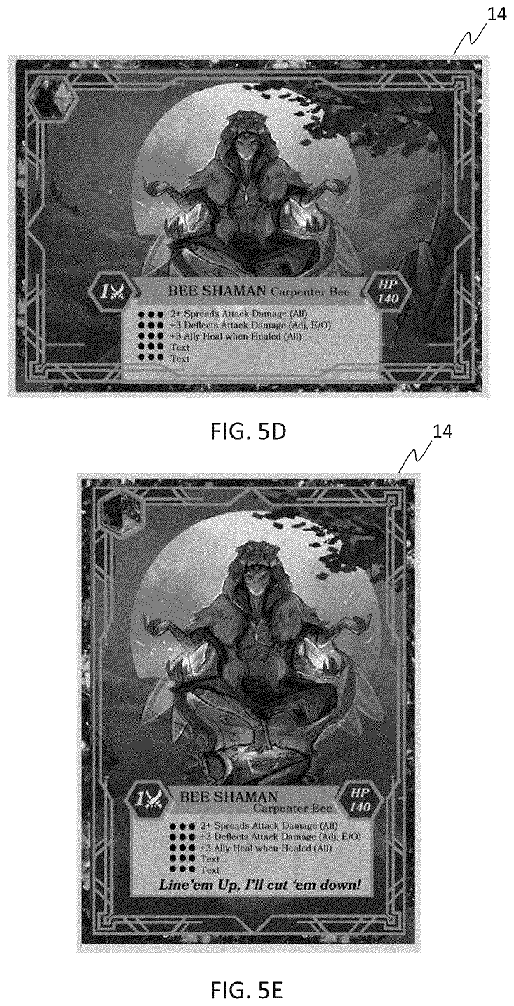

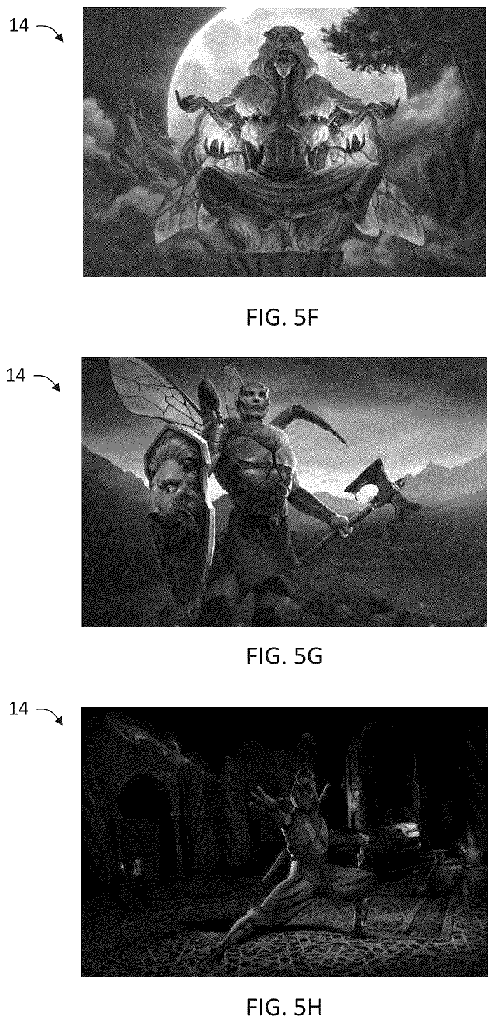

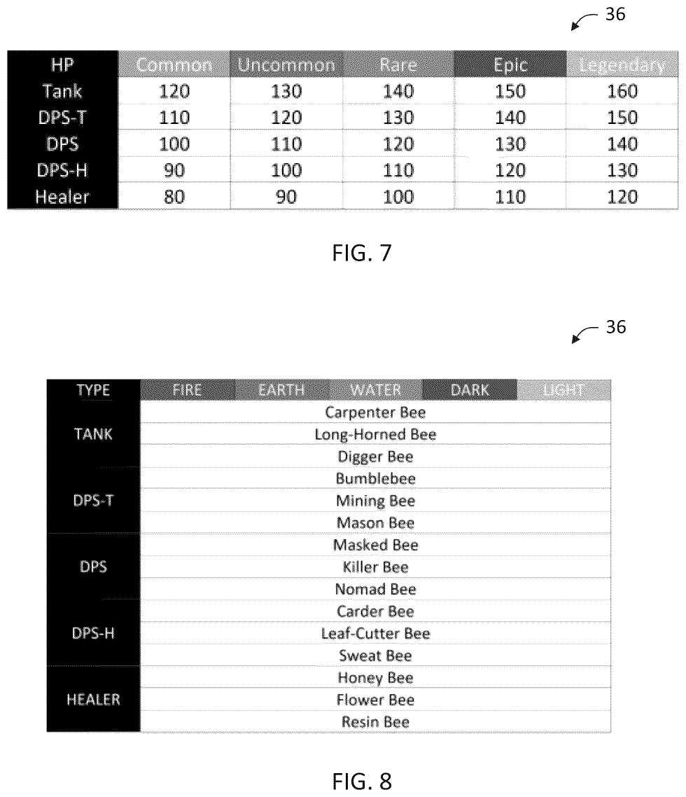

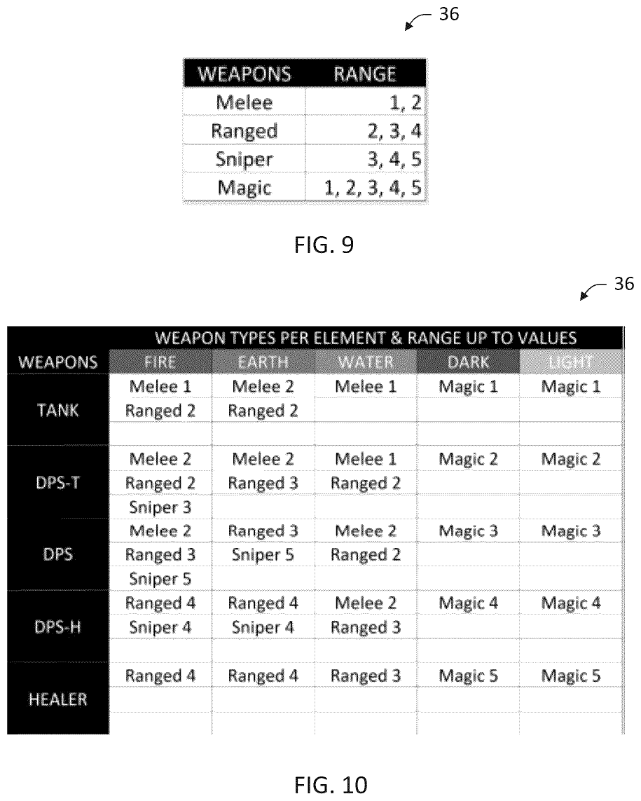

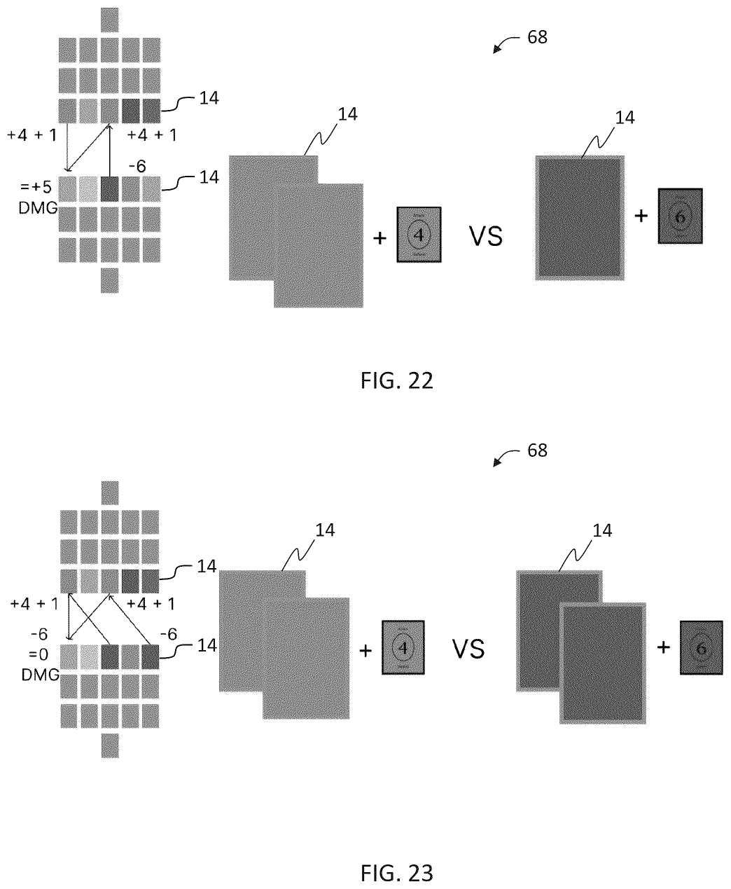

Referring to FIG. 1, the present invention is directed to a networked computer system 10 for rendering animated sequences of computer-generated images of a trading card game 12 (shown in FIGS. 3-28) using non-fungible tokens (NFT) of hero trading cards 14. In the illustrated embodiment, the network system 10 includes a web3.0 cloud platform 16 including one or more processors that are coupled in communication with a plurality of user computing devices 18 and one or more NFT blockchain systems 20. The user computing devices 18 may include, for example, smartphones, tablet computers, personal computers, virtual-reality headsets, augmented-reality glasses, and/or any suitable device that include display devices that are configured to display animated sequences of computer-generated images and graphic user-interfaces that allow users to interact with the network 10.

The NFT blockchain system 20 includes a blockchain network system that supports NFTs such as, for example, Fantom™, Ethereum™, Flow™, Tezos™, and/or any suitable blockchain network.

The web3.0 cloud platform 16 includes a plurality of software program modules including computer-executable instructions that may be executed the computer processor to perform the algorithms describe herein to allow the system 10 to access the NFT blockchain system 20, verify NFT ownership and render animated sequences of computer-generated images of a Battle Blitz™ trading card game 12 (shown in FIGS. 3-28) using non-fungible tokens (NFT) of Battle Blitz™ hero trading cards 14 on user computing devices 18 to enable players to participate in the trading card game 12.

In some embodiments, the web3.0 cloud platform 16 includes a Battle Blitz™ trading card game software module 22, a Battle Blitz™ trading card NFT wallet software module 24, a crypto-currency wallet software module 26, and Battle Blitz™ trading card game smart contracts 28.

The Battle Blitz™ trading card game software module 22 includes computer-executable instructions for rendering animated sequences of computer-generated images of a Battle Blitz™ trading card game 12 displayed on the user computing devices 18 to allow users to interact with the network 10 to play the Battle Blitz™ trading card game 12.

The Battle Blitz™ trading card NFT wallet software module 24 includes computer-executable instructions for executing an algorithm to enable users to accept/manage/trade NFT hero trading cards 14 for use in the Battle Blitz™ trading card game 12.

The crypto-currency wallet software module 26 includes computer-executable instructions for executing an algorithm to enable users to accept/manage legacy and crypto currency such as, for example $COMB™, issued by COMB™.

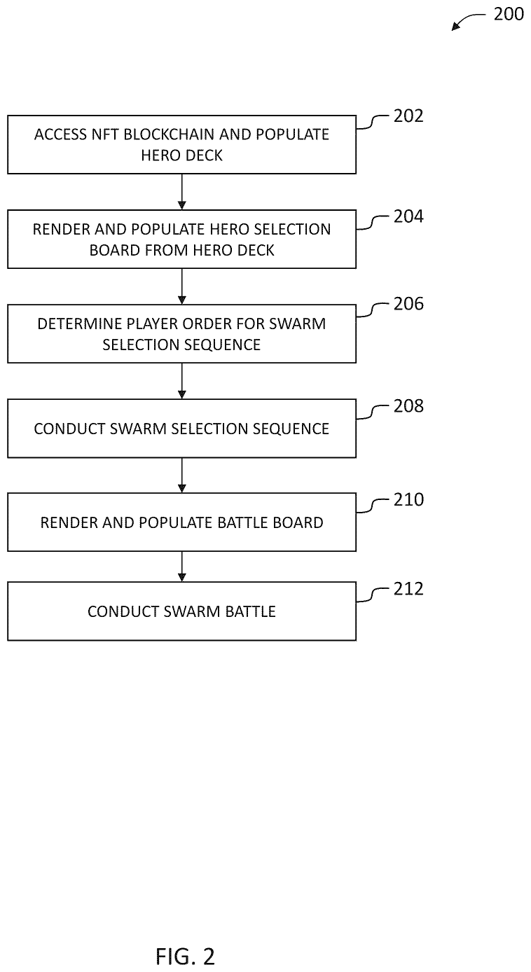

The Battle Blitz™ trading card game smart contracts 28 include computer-executable instructions published to the blockchains system for executing the algorithms 200 shown in FIGS. 2-30 for use in executing the Battle Blitz™ trading card game 12 displayed on the user computing devices 18.

In the illustrated embodiment, the Battle Blitz™ trading card game 12 is played between two players with each player including a hero trading card deck 30 including a plurality of hero trading cards 14 and an action card deck 32 including a plurality of action cards 34.

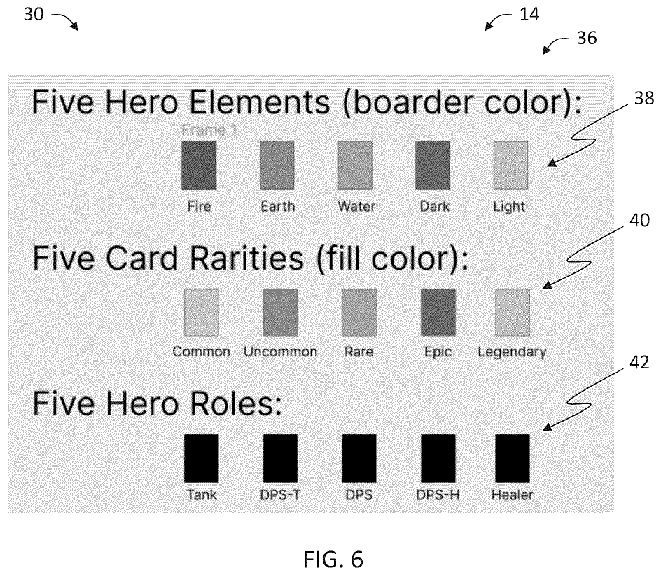

Each hero trading card 14 indicates a corresponding hero character in the Battle Blitz™ trading card game 12 including a plurality of character aspects 36 (shown in FIG. 6). For example, in some embodiments, each hero trading card 14 may indicate character aspects including a hero element 38 (e.g., Fire, Earth, Water, Dark, Light), a card rarity 40 (e.g., Common, Uncommon, Rare, Epic, and Legendary), and a hero role 42 (e.g., Tank, DPS-T, DPS, DPS-H, and Healer). The hero roles 42 may be associated with various hero characters such as, for example, fifteen hero types including: a. Tank: Carpenter, Long-Horned, Digger; b. DPS-T: Bumblebee, Mining, Mason; c. DPS: Masked, Killer, Nomad; d. DPS-H: Carder, Leaf-Cutter, Sweat; and e. Healer: Honey, Flower, Resin. In addition each hero element 38 may be associated with different hero characters such as Fighter Type by Element (natural and supernatural) including: a. Fire=Assassin-Ninja, etc.; b. Earth=Hunter-Ranger, Archer etc.; c. Water=Warrior-Fighter etc.; d. Dark=Unholy-Sage, Wizard, etc.; and e. Light=Holy-Priest, Enchanter, etc.

In some embodiment, the hero trading card deck 30 may include 125 hero trading cards 14 including: a. Tank: 25 Heroes, one of each type and element; b. DPS-T: 25 Heroes, one of each type and element; c. DPS: 25 Heroes, one of each type and element; d. DPS-H: 25 Heroes, one of each type and element; and e. Healer: 25 Heroes, one of each type and element.

Each hero trading card 14 also includes a Skills/Ability value 44 displayed on the hero trading card 14 indicating a point value associated with the corresponding skill/ability of the hero character

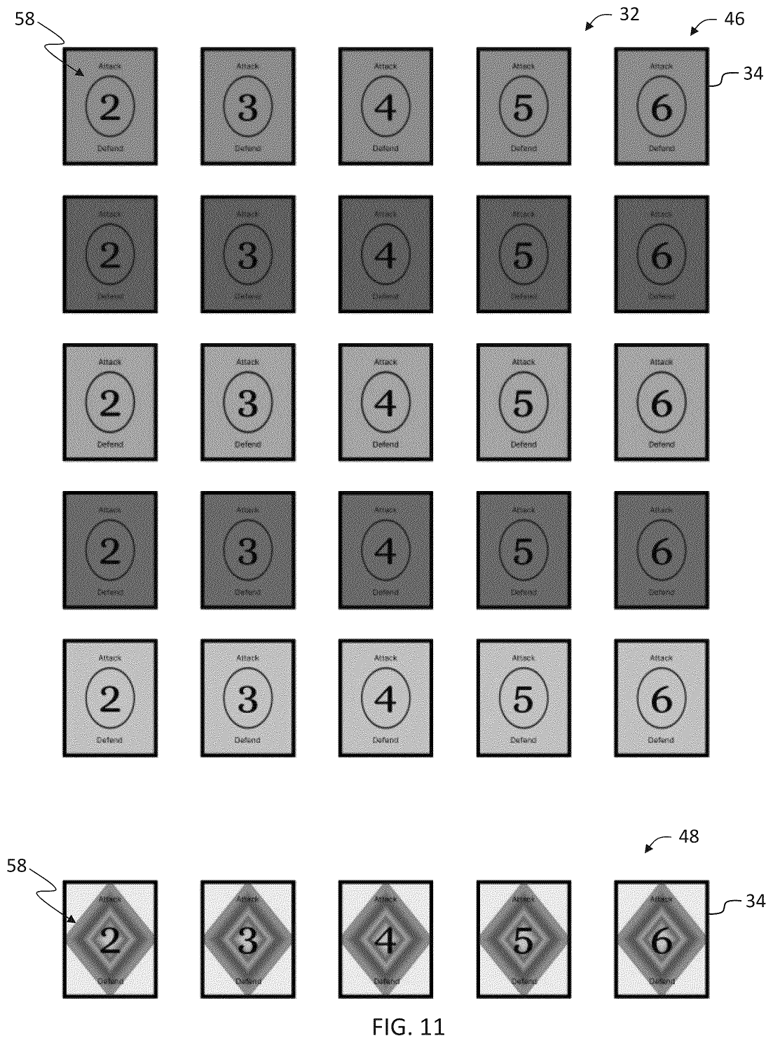

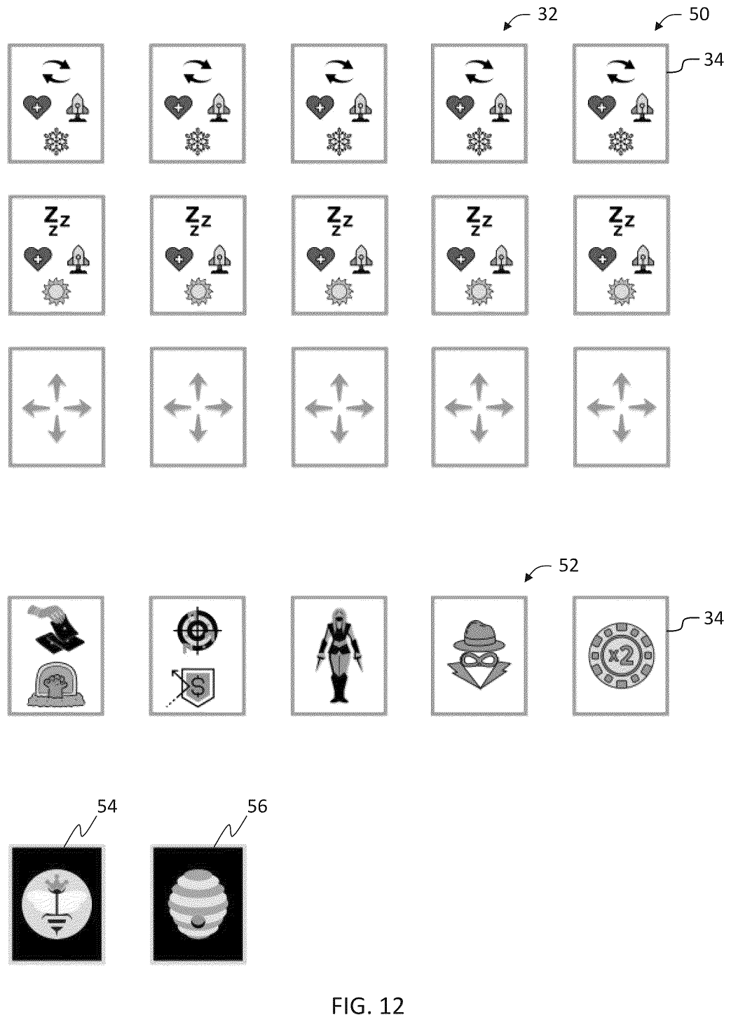

The action card deck 32 (shown in FIGS. 11-12) includes a set of fifty-two cards including twenty-five regular action cards 46, five unique action cards 48, fifteen regular specials cards 50, five unique specials cards 52, one Queen Bee card 54, and one Expose/Hide the Queen card 56.

Each regular action card 46 and unique action card 48 includes an attack damage value 58 displayed on the action card. Each regular action card 46 is associated with a corresponding hero element 38. Each unique action card 48 may be used with any hero trading card 14.

The Battle Blitz™ trading card game 12 also includes one or more hero selection boards 60 (shown in FIG. 3) and one or more battle boards 62. The hero selection boards 60 are used by players to select one or more squads 64 of hero trading cards 14 used to populate the battle boards 62 used during the game. In some embodiments, the Battle Blitz™ trading card game 12 may also include poker chips (not shown) including 150 yellow poker chips and 50 black poker chips that may be used to indicate enhanced abilities of hero trading cards 14 used during the game.

FIG. 2 are flowcharts of methods 200 illustrating the algorithms executed by the network 10 for rendering animated sequences of computer-generated images of the Battle Blitz™ trading card game 12 using non-fungible tokens (NFT) of Battle Blitz™ hero trading cards 14 on user computing devices 18. The methods include a plurality of steps. Each method step may be performed independently of, or in combination with, other method steps. Portions of the methods may be performed by any one of, or any combination of, the components of the network 10.

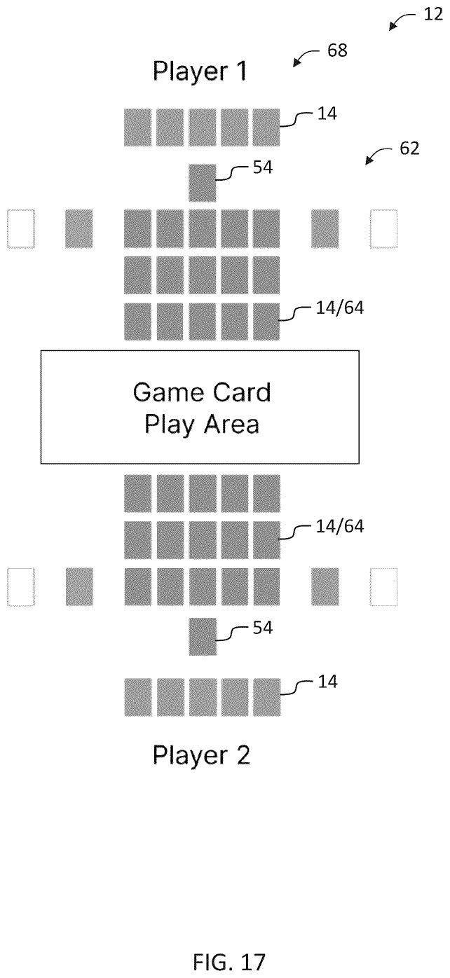

For example, in some embodiments, in method step 202, a processor of the web 3.0 cloud platform 16 may receive a request by one or more players via user computing devices 18 to play the Battle Blitz™ trading card game 12. Upon receiving the request, the Battle Blitz™ trading card game software module 22 may access the Battle Blitz™ trading card NFT wallet software module 24 to determine NFT hero trading cards 14 currently owned or leased by a player and populate a hero trading card deck 30 associated with the player including NFT hero trading cards 14 currently owned or leased by the player. The Battle Blitz™ trading card game software module 22 may then render a hero selection board 60 on the display device of the user computing device 18 to enable the player to perform a squad selection sequence 66 (shown in FIGS. 3, 14-16) to select one or more squads 64 for use during a squad battle sequence 68 (shown in FIGS. 17-28).

Upon populating the hero trading card deck 30, the processor may execute method step 204 to render the hero selection boards 60 on the user computing devices 18 and execute a squad selection sequence 66 to enable one or more players to select one or more squads 64 that may be used to populate a battle board 62 used during a squad battle sequence 68 (shown in FIGS. 17-28). In the illustrated embodiment, the hero selection board 60 includes a plurality of cells 70 arranged in a grid 72. For example, as shown in FIG. 3, the hero selection board 60 may include twenty-five cells 70 arranged in a 5×5 grid 72. Each cell 70 is populated with a hero trading card 14 during the squad selection sequence 66. In one embodiment, the hero selection board 60 includes a plurality of common card cells 74 that are populated with hero trading cards 14 having a Common card rarity 40 and a plurality of uncommon card cells 76 that are populated with hero trading cards 14 having an Uncommon card rarity 40. In some embodiments, the processor may randomly select hero trading cards 14 from the hero trading card deck 30 to populate the hero selection board 60. In other embodiments, the processor allows the player to select hero trading cards 14 from the hero trading card deck 30 to populate the hero selection board 60.

In the illustrated embodiment, the processor enables the player to select twenty-five hero trading cards 14 to populate the hero selection board 60 including four hero trading cards 14 having Common card rarity 40 positioned within the common card cells 74 and four hero trading cards 14 having Uncommon card rarity 40 positioned within the uncommon card cells 76. The remaining cells 70 are populated with hero trading cards 14 such that none of the cells 70 include hero trading cards having the same hero element 38 and card rarity 40.

In some embodiments, the processor may calculate a strength point value associated with a populated the hero selection board 60 based on strength values associate with each hero trading card 14 displayed on the hero selection board 60. For example, in some embodiments, each hero trading card 14 may include a strength value associated with a corresponding card rarity 40. For example, boards may have total scores to control competition (like weight class): a. Common=1 point; b. Uncommon=2 points; c. Rare=3 points; d. Epic=4 points; and e. Legendary=5 points.

In the illustrated embodiment, upon populating the hero selection board 60 with the hero trading cards 14, the processor executes method step 206 to implement a player order selection sequence to determine a player order for conducting the squad selection sequence 66. In the illustrated embodiment, the squad selection sequence 66 is conducted between two players. The player order selection sequence begins with each player having separated fifteen Red, Green, Blue (RGB) element action cards 46 from a respective action card deck 32. The players will proceed to shuffle their 15 RGB element action cards. Once shuffled, each player will turnover a card. The player with the highest value or stronger card in a tie wins and will set their winning card to the side while the losing player will discard their losing card into a discard pile. If the exact same card is drawn by both players, the result will be a tie for that match and each player will discard their card. The player order selection sequence concludes when a player obtains three wins, which then allows that player to conduct the first squad selection in the squad selection sequence 66.

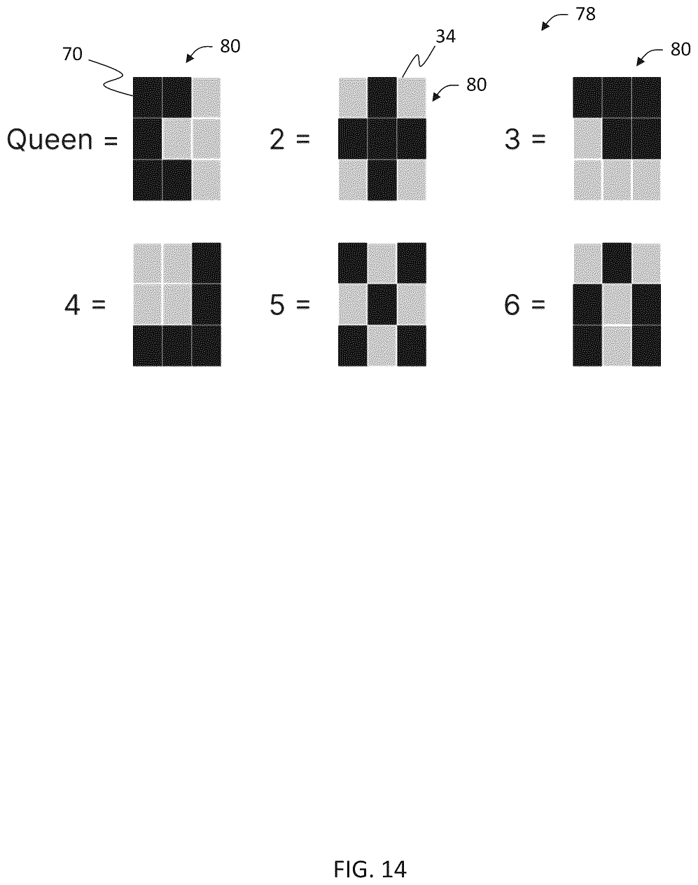

Upon completing the player order selection sequence, the processor executes method step 208 to conduct the squad selection sequence 66 to select squads 64 of hero trading cards 14 used to populate the battle board 62. In method step 208, the processor provides a squad selection deck 78 (shown in FIG. 14) that includes a plurality of action cards 34 that are selected from the action card deck 32 (shown in FIG. 11). Each action card 34 included in the squad selection deck 78 is associated with a corresponding selection shape 80. Each selection shape 80 includes a different arrangement of cells 70 that are used to select hero trading cards 14 from the hero selection board 60. In the illustrated embodiment, the squad selection deck 78 includes the Queen Bee card 54 and five action cards 34 having an attack damage value 58 numbered between 2-6. The squad selection deck 78 includes cards having 6 different selection shapes 80. During the squad selection sequence 66, three cards will be drawn from the squad selection deck 78 to define three squads 64 of hero trading cards 14 for use in the squad battle sequence 68.

For example, in some embodiments, the one or more processors of the web3.0 cloud platform 16 are programmed to execute an algorithm to render animated sequences of computer-generated images of a trading card game 12 on the user computing devices 18 including the steps of: receiving a request by a player via a corresponding user computing device 18 to play the trading card game 12 and querying a trading card NFT wallet software module 24 to access data stored on the NFT blockchain system 20 to determine NFT hero trading cards 14 currently owned by the player. The processors of the web3.0 cloud platform 16 then populate a hero trading card deck 30 associated with the player including the NFT hero trading cards 14 currently owned by the player and conduct a squad selection sequence 66 by: rendering a hero selection board 60 on the user computing device 18 including a plurality of cells 70 arranged in a grid 72 with each cell populated with an NFT hero trading card 14 selected from the hero trading card deck 30, randomly selecting a squad selection shape 80 including a predefined arrangement of cells, and selecting a squad 64 of NFT hero trading cards by selecting a group of NFT hero trading cards 14 from the hero selection board 60 based on the squad selection shape 80. The processors of the web3.0 cloud platform 16 then animate a battle board 62 onto the user computing device 18 that includes the selected squad 64 of NFT hero trading cards 14.

The processors of the web3.0 cloud platform 16 may be programmed to render the hero selection board including twenty-five cells arranged in a 5×5 grid, as shown in FIG. 3. The processors of the web3.0 cloud platform 16 may also render the hero selection board 60 including a plurality of common card cells populated with hero trading cards having a Common card rarity and a plurality of uncommon card cells populated with hero trading cards having an Uncommon card rarity, and receive player selections of the NFT hero trading cards from the hero trading card deck to populate the hero selection board.

In some embodiments, the processors of the web3.0 cloud platform 16 may be programmed to populate a squad selection deck 78 including action cards 34 having different squad selection shapes 80 and randomly select an action card 34 from the squad selection deck 78 to establish the squad selection shape 80. The processors of the web3.0 cloud platform 16 may also render each action card having nine cells arranged in a 3×3 matrix including a corresponding squad selection shape defined by five cells, and populate the squad selection deck 78 including six action cards 34 having different selection shapes 80, as shown in FIG. 14.

In the illustrated embodiment, the player who wins the player order selection sequence will either elect to go first in the squad selection or defer their selection. At this point, the players will retrieve five action cards, each with a different number 2-6 and they will retrieve the Queen Bee card who will represent number 1 to form the squad selection deck 78. The players will shuffle their respective cards and lay all six in a row in front of them. The player who selects the first squad will reach across to the opposing player's cards and choose a card. The corresponding number the player selects will translate to the corresponding selection shape 80.

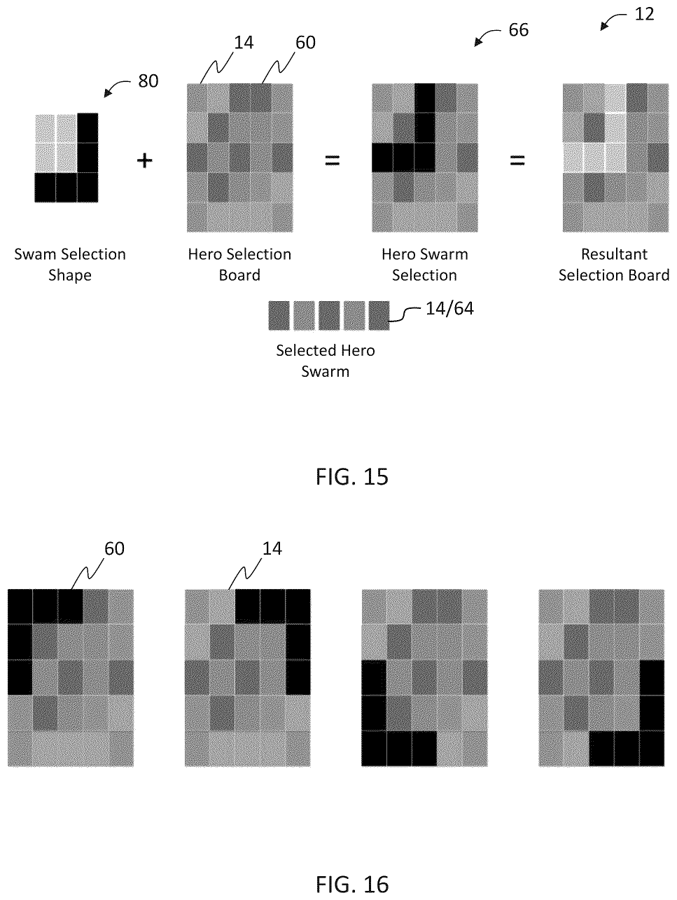

The selecting player will then select any group of five hero cards 14 that fit within the shape that they selected on their board. For example, as shown in FIGS. 15-16, player 1 has drawn the number 4 from his opponent's cards and possesses a hero selection board 60. The player then overlays the selection shape 80 onto the hero selection board 60 to select the corresponding hero trading cards 14 to define a 1^{st} squad to be used in the squad battle sequence 68. As shown in FIG. 16, the selection shape 80 can be rotated or flipped to select any squad 64 of hero trading cards 14 remaining on the hero selection board 60. Once the squad 64 of hero trading cards 14 is selected, the player's number is discarded from the squad selection deck 78. Therefore, the same number can never be selected in the same game by the same player so no two shapes will be played twice.

Upon Player 1 having made their selection, Player 2 will draw a card from Player 1 and pick their squad. Once Player 2 has selected their squad and discarded then Player 2 will select a second card and choose their second squad. Therefore, the selection process will always be a 1,2,2, 1 process for the sake of parity. Once Player 2 has selected their two squads, Player 1 will proceed to select their 2^{nd} and 3^{rd} squads. Player 2 will finish the selection process with their 3^{rd} squad selection. At this point, both players will have three squads selected and they cannot mix and match these selections. However, what they will do next is organize the order of Heroes in each squad from left to right in a row and place them in three rows that will make-up five columns to form the battle board 62 (shown in FIG. 17).

Upon completing the squad selection sequence 66, the processor executes method step 210 to render and populate the battle board 62. In method step 210, the processor enables players to choose any squad to place in the top, middle, and bottom rows. Their squads 64 do not have to be placed in the order that they were selected, but they can be. The players will place the three squads face down until each player has set their squads and are ready for battle. Once both players have confirmed that they are set, they will turnover their respective top squad and keep their remaining two squads hidden. Once the squads are set and ready for battle, each player will reach for their Queen 54 that was brought into the squad selection sequence. The queen will be placed face down behind the three rows under the middle column. The 2 players have their boards set and are now ready for battle!

The processor then executes method step 212 to conduct the squad battle sequence 68 using the squads 64 of hero trading cards 14 arranged on the battle board 62. During the squad battle sequence 68, the battle board 62 is setup with both players facing each other with a clear gap between them for game card play. The front-five Hero cards for each player will be positioned face up. The two cards in the rear of each player's three squads 64 is the Queen 54. The Queen will always start in the center of each player's formation.

Before the battle begins, each player will shuffle the remaining 51 cards in their game card decks. Once both players finish shuffling, they will set their decks down and each will draw five action cards to form an initial battle deck. The player who selected their squad first will play defense and the other player will be on offense. The remaining Hero cards should be taken out of the matrix, shuffled, and placed to the side of the battlefield as well. The five game cards included in the battle deck can be organized by each player and played out of their respective hands like 5 card draw poker. When the action starts, the Offense will start by placing game cards from the battle deck, one at a time, in the Game Card Play Area. For every card that the offense plays, the defense will be able to counter prior to the offense making another maneuver.

The battle begins with the offensive player making the following choice: a. Play a card from the five in their hand; or b. “Pass”-End Turn. If the player on offense chooses to play a card then the defense will have an opportunity to respond. The offensive player can subsequently play as many of their five cards as they wish, but the defense has an opportunity to respond to each one.

When the player on offense chooses to “Pass” then both players will enter a discard round. Each player can choose to discard or keep as many of their 5 cards from the battle deck as they prefer. A player who decides not to discard will “Stand Pat.” Once the players have finished the discard round, they will replenish their hands to a total of five cards from the game deck.

Assuming that the offensive player plays a card, there are 3 kinds of cards that the offensive player will be able to play: a. Action Card; b. Specials Card; and/or c. Reveal/Hide the Queen.

### Action Card Play (Offense):

Each action card 46, 48 is color coded Green, Red, Blue, Purple, Gold, or “Wild”. Each action card 46, 48 is to be used with Heroes 14 who have matching Elements. For example, an Earth Hero can attack with a Green card, whereas a Fire Hero would attack with a red card.

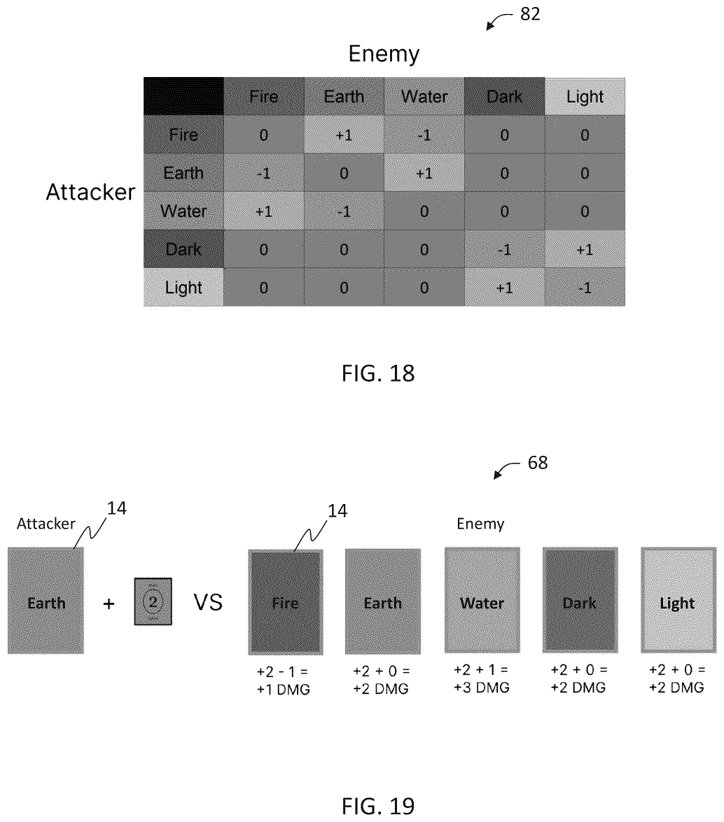

The attack damage (DMG) value 58 listed on the action card 46, 48 is a baseline. In other words, the final DMG given to an enemy is based on who the Hero is attacking plus the Skills/Abilities of the attacker versus the Skills/Abilities of the enemy being attacked. The baseline DMG matrix 82 is shown in FIG. 18.

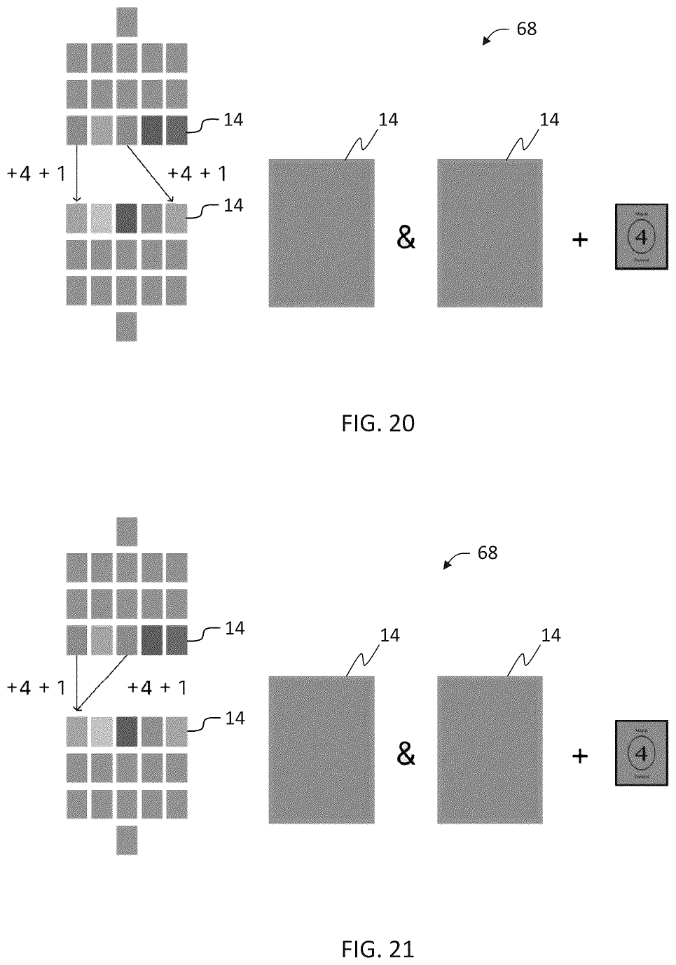

squad battle sequence 68, action cards apply to the total number of Heros on the board who have the same element, independently. For example, as shown in FIG. 20, if the top board is playing offense and the player has a green 4 action card then the player's two Earth Heroes will each be able to target an enemy and apply +4 base DMG. In addition, as shown in FIG. 21, both offensive Earth Heroes can attack the same enemy Hero.

The wild card can be used with any Hero and applies the rules of the color declared by the player. Therefore, a wild card used with an Earth Hero will be green, for example.

### Acton Card Play (Defense):

Action cards are used for both offensive and defensive maneuvers, but they are not used the same way. Sticking with the example above, assume that an offensive player plays a +4 Green card. The defensive counter would have to be a red card, but the defense must also possess at least one Fire Hero to use the card. Should the defense possess more than one counter Hero then the counter card will apply to all Heroes of the same color.

For example, as shown in FIGS. 23-23, the offensive player has played GAC4 (Green Action Card 4). If the defensive player had a RACX (Red Action Card) then they would counter one of the Earth Hero's attacks with as many Red Heroes as they have active on the board.

Counter attacks are face value, which means that if the defender had a RAC6 then the defender could counter one of the offensive maneuvers to a zero attack score. Even though 6>5, the defender cannot exceed the action points of the offense attack unless their Hero has a skill/ability that lets them do so.

As shown in FIG. 23, in this example, there are now two Fire Heroes on defense, If the defensive player had RAC6 then they would counter both of the Earth Hero's attacks and neutralize the attacks completely.

### Specials Card Play:

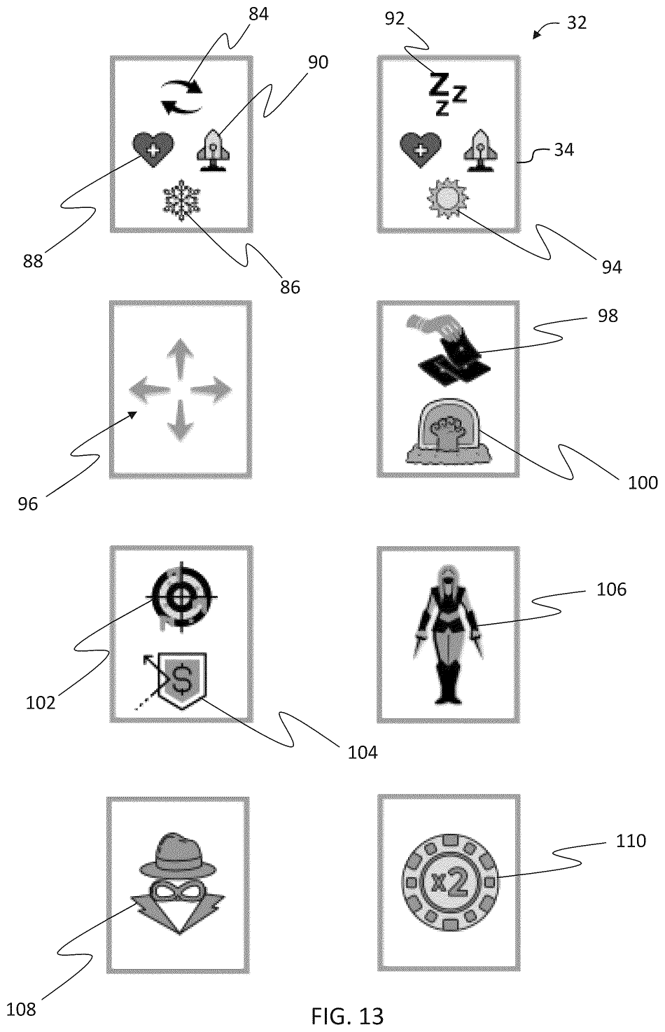

Referring to FIGS. 12-13, the action card deck 32 includes a set of fifty-two cards including twenty-five regular action cards 46, five unique action cards 48, fifteen regular specials cards 50, five unique specials cards 52, one Queen Bee card 54, and one Expose/Hide the Queen card 56.

There are three kinds of regular Specials cards and 5 unique Specials cards. Each icon on the card represents a different choice the player can make with the card, but the player can only make one choice and must discard once the card is used.

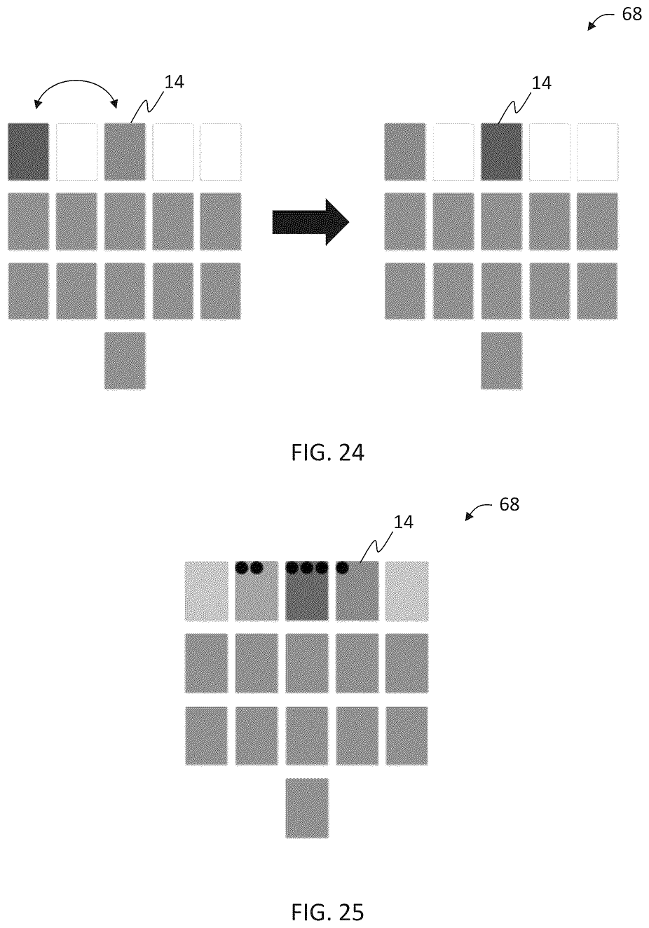

Swap symbol 84: a player on offense can use the card with the swap symbol 84 to swap one Hero in one position for another Hero in another position, as shown in FIG. 24.

Freeze symbol 86: a player on defense can use the card with the freeze symbol 86 to freeze an offensive player who is making a swap from being able to do so.

Heal symbol 88: a player on offense can use the card with the heal symbol 88 to heal Heroes but the player must have an active Healer Hero to use this card. If the player has more than one Healer then the player must choose which Hero to use. Only one Healer can be used per card unless there is a Hero skill/ability that says otherwise. Furthermore, all healers specify the amount that they can heal and who they can heal.

Boost symbol 90: a player on offense can use the card with the boost symbol 90 to boost a Hero 1 level with a rarity >Common and <Legendary. All non-Legendary Heros start the game at Level 1 (LI) and must be boosted to activate their next level. As shown in FIG. 25, in this example, the Uncommon, Rare, and Epic cards can all be leveled. Black chips will signal their level (1 Chip=L2; 2=L3; & 3=L4).

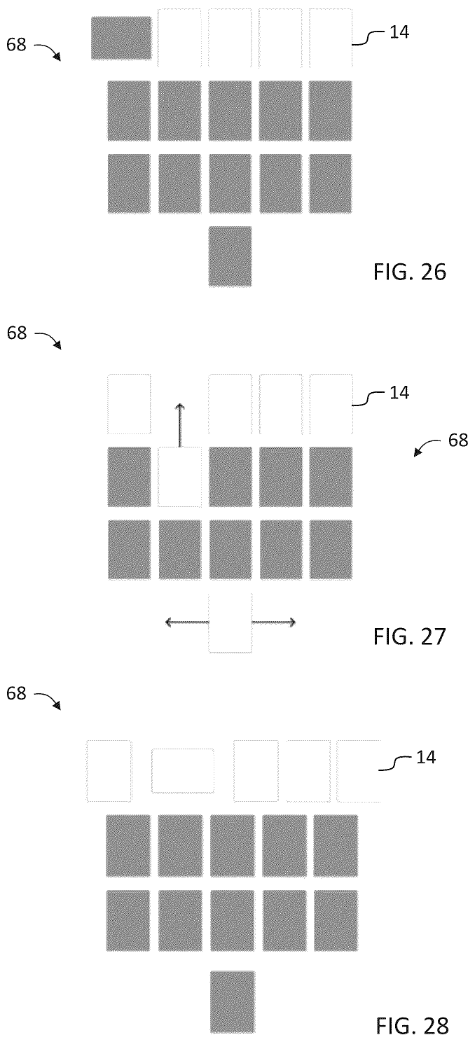

Sleep symbol 92: a player on offense can use the card with the sleep symbol 92 to put an enemy to sleep. Heroes asleep cannot attack or be attacked unless they have a skill/ability that says otherwise. As shown in FIG. 26, in this example, a player who is put to sleep is turned over and placed sideway to demonstrate that the player is active but sleeping compared to not being activated.

Wake-up symbol 94: a player on offense can use the card with the wake-up symbol 94 to wake a Hero from their sleep or to activate a Hero in a squad who has not been activated.

Move symbol 96: as Heroes get eliminated, spaces will open in their wake. These cards allow for a player on offense to move their Heroes up, down, left, and right 1 space. A Hero must be active to move, including the Queen, as shown in FIG. 27.

Draw a Hero symbol 98: there are 10 Heroes remaining after the selection process. So long as a void exists on the board, a player on offense can draw a Hero from the Benched Heroes pile to fill the void.

Resurrect a Hero symbol 100: when players get eliminated, they are placed in a new discard pile next to the Benched Heroes pile. A player on offense must shuffle the Hero discard pile before resurrecting a Hero.

Killshot symbol 102: a player on offense can use the card to insta-kill an enemy regardless of the enemies remaining HP or element. The killshot cannot be used on a Queen.

Deflect a killshot symbol 104: a player on defense can use the card to deflect a killshot back onto the Hero who takes the shot for an insta-kill.

Saboteur symbol 106: a player on offense can use the card to turn an enemy Hero into an ally. The saboteur will be turned sideways and face up in the enemy's squad to identify its status, as shown in FIG. 28.

Thief symbol 108: a player on offense can use the card to take possession of the defensive player's cards. The player on defense must expose their cards face up and the offensive player must use the cards on the same turn or any remaining cards will be discarded by the defender at the end of the turn.

Double down symbol 110: a player on offense can use the card to draw 5 more cards from their game deck. The player may retain as many cards as they wish, but cannot draw new cards until the cards in their hand is less than 5.

### Reveal/Hide Queen:

To attack the Queen, she must be revealed. To move the Queen she must be revealed. The Reveal/Hide Queen card 56 can be used on your Queen if you want to move her or on the opponent's Queen for attack.

The Queen 54 has 150 HP. Killshots, Sleep, and Awake Specials do not work on the Queen unless a Hero has the skills/abilities to perform the maneuver.

### How to Win:

There are three ways to win: 1. Capture the Queen. 2. Eliminate all squads. 3. Opponent Forfeits.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. In addition, a central processing unit (CPU) may include one or more processors as described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

What is claimed is:

1. A networked computer system comprising:
a plurality of user computing devices;
a non-fungible token (NFT) blockchain system storing ownership data associated with virtual trading cards; and
a web3.0 cloud platform including one or more processors coupled to the plurality of user computing devices and to the NFT blockchain system, the one or more processors programmed to execute an algorithm to render animated sequences of computer-generated images of a trading card game on the user computing devices including the steps of:
receiving a request by a player via a corresponding user computing device to play the trading card game;
querying a trading card NFT wallet software module to access data stored on the NFT blockchain system to determine NFT hero trading cards currently owned by the player;
populating a hero trading card deck associated with the player including the NFT hero trading cards currently owned by the player;
conducting a squad selection sequence by:
rendering a hero selection board on the user computing device including a plurality of cells arranged in a grid, each cell populated with an NFT hero trading card selected from the hero trading card deck;
randomly selecting a squad selection shape including a predefined arrangement of cells; and
selecting a squad of NFT hero trading cards by selecting a group of NFT hero trading cards from the hero selection board based on the squad selection shape; and
animating a battle board onto the user computing device including the selected squad of NFT hero trading cards.

2. The networked computer system of claim 1, wherein the one or more processors is programmed to execute the algorithm including the steps of:
rendering the hero selection board including twenty-five cells arranged in a 5×5 grid.

3. The networked computer system of claim 2, wherein the one or more processors is programmed to execute the algorithm including the steps of:
rendering the hero selection board including a plurality of common card cells populated with hero trading cards having a Common card rarity and a plurality of uncommon card cells populated with hero trading cards having an Uncommon card rarity.

4. The networked computer system of claim 1, wherein the one or more processors is programmed to execute the algorithm including the steps of:
receiving player selections of the NFT hero trading cards from the hero trading card deck to populate the hero selection board.

5. The networked computer system of claim 1, wherein the one or more processors is programmed to execute the algorithm including the steps of:
populating a squad selection deck including action cards having different squad selection shapes; and
randomly selecting an action card from the squad selection deck to establish the squad selection shape.

6. The networked computer system of claim 5, wherein the one or more processors is programmed to execute the algorithm including the steps of:
rendering each action card having nine cells arranged in a 3×3 matrix including a corresponding squad selection shape defined by five cells.

7. The networked computer system of claim 6, wherein the one or more processors is programmed to execute the algorithm including the steps of:
populating the squad selection deck including six action cards having different selection shapes.

8. A method of operating a networked computer system including a plurality of user computing devices, a non-fungible token (NFT) blockchain system storing ownership data associated with virtual trading cards, and a web3.0 cloud platform including one or more processors coupled to the plurality of user computing devices and to the NFT blockchain system, the method including the one or more processors performing an algorithm to render animated sequences of computer-generated images of a trading card game on the user computing devices including the steps of:
receiving a request by a player via a corresponding user computing device to play the trading card game;
querying a trading card NFT wallet software module to access data stored on the NFT blockchain system to determine NFT hero trading cards currently owned by the player;
populating a hero trading card deck associated with the player including the NFT hero trading cards currently owned by the player;
conducting a squad selection sequence by:
rendering a hero selection board on the user computing device including a plurality of cells arranged in a grid, each cell populated with an NFT hero trading card selected from the hero trading card deck;
randomly selecting a squad selection shape including a predefined arrangement of cells; and
selecting a squad of NFT hero trading cards by selecting a group of NFT hero trading cards from the hero selection board based on the squad selection shape; and
animating a battle board onto the user computing device including the selected squad of NFT hero trading cards,
randomly selecting a squad selection shape including a predefined arrangement of cells; and
selecting a squad of NFT hero trading cards by selecting a group of NFT hero trading cards from the hero selection board based on the squad selection shape; and
animating a battle board onto the user computing device including the selected squad of NFT hero trading cards.

9. The method of claim 8, including the one or more processors performing the algorithm including the steps of:
rendering the hero selection board including twenty-five cells arranged in a 5×5 grid.

10. The method of claim 9, including the one or more processors performing the algorithm including the steps of:
rendering the hero selection board including a plurality of common card cells populated with hero trading cards having a Common card rarity and a plurality of uncommon card cells populated with hero trading cards having an Uncommon card rarity.

11. The method of claim 8, including the one or more processors performing the algorithm including the steps of:
receiving player selections of the NFT hero trading cards from the hero trading card deck to populate the hero selection board.

12. The method of claim 8, including the one or more processors performing the algorithm including the steps of:
populating a squad selection deck including action cards having different squad selection shapes; and
randomly selecting an action card from the squad selection deck to establish the squad selection shape.

13. The method of claim 12, including the one or more processors performing the algorithm including the steps of:
rendering each action card having nine cells arranged in a 3×3 matrix including a corresponding squad selection shape defined by five cells.

14. The method of claim 13, including the one or more processors performing the algorithm including the steps of:
populating the squad selection deck including six action cards having different selection shapes.

15. A non-transitory computer-readable storage media having computer-executable instructions embodied thereon to operate a networked computer system including a plurality of user computing devices, a non-fungible token (NFT) blockchain system storing ownership data associated with virtual trading cards, and a web3.0 cloud platform including one or more processors coupled to the plurality of user computing devices and to the NFT blockchain system, when executed by the one or more processors the computer-executable instructions cause the one or more processors to perform an algorithm to render animated sequences of computer-generated images of a trading card game on the user computing devices including the steps of:
receiving a request by a player via a corresponding user computing device to play the trading card game;
querying a trading card NFT wallet software module to access data stored on the NFT blockchain system to determine NFT hero trading cards currently owned by the player;
populating a hero trading card deck associated with the player including the NFT hero trading cards currently owned by the player;
conducting a squad selection sequence by:
rendering a hero selection board on the user computing device including a plurality of cells arranged in a grid, each cell populated with an NFT hero trading card selected from the hero trading card deck;
randomly selecting a squad selection shape including a predefined arrangement of cells; and
selecting a squad of NFT hero trading cards by selecting a group of NFT hero trading cards from the hero selection board based on the squad selection shape; and
animating a battle board onto the user computing device including the selected squad of NFT hero trading cards,
randomly selecting a squad selection shape including a predefined arrangement of cells; and
selecting a squad of NFT hero trading cards by selecting a group of NFT hero trading cards from the hero selection board based on the squad selection shape; and
animating a battle board onto the user computing device including the selected squad of NFT hero trading cards.

16. The non-transitory computer-readable storage media of claim 15, wherein the computer-executable instructions cause the one or more processors to perform the algorithm including the steps of:
rendering the hero selection board including twenty-five cells arranged in a 5×5 grid.

17. The non-transitory computer-readable storage media of claim 16, wherein the computer-executable instructions cause the one or more processors to perform the algorithm including the steps of:
rendering the hero selection board including a plurality of common card cells populated with hero trading cards having a Common card rarity and a plurality of uncommon card cells populated with hero trading cards having an Uncommon card rarity.

18. The non-transitory computer-readable storage media of claim 15, wherein the computer-executable instructions cause the one or more processors to perform the algorithm including the steps of:
receiving player selections of the NFT hero trading cards from the hero trading card deck to populate the hero selection board.

19. The non-transitory computer-readable storage media of claim 15, wherein the computer-executable instructions cause the one or more processors to perform the algorithm including the steps of:
populating a squad selection deck including action cards having different squad selection shapes; and
randomly selecting an action card from the squad selection deck to establish the squad selection shape.

20. The non-transitory computer-readable storage media of claim 19, wherein the computer-executable instructions cause the one or more processors to perform the algorithm including the steps of:
rendering each action card having nine cells arranged in a 3×3 matrix including a corresponding squad selection shape defined by five cells; and
populating the squad selection deck including six action cards having different selection shapes.
